(19) United States
(12) Patent Application Publication
(10) Pub. No.: US 2009/0120373 A1
(43) Pub. Date: May 14, 2009

(54) Ultrasonic trainer with user selectable frequency ranges

(76) Inventors: Troy A. Wetzel, Mohnton, PA (US); Richard L. Eyer, Lititz, PA (US)

Correspondence Address: JACOBSON HOLMAN PLLC, 400 SEVENTH STREET N.W., SUITE 600, WASHINGTON, DC, 20004, US

(21) Appl. No.: 11/979,891

(22) Filed: Nov. 9, 2007

(51) Int. Cl. A01K 15/02

(52) U.S. Cl. 119/719

(57) ABSTRACT

An ultrasonic device is provided for training a dog to cease from certain undesirable behaviors using a short ultrasonic burst that sweeps across multiple frequencies in one of several user-selected ranges. The user can program the device to a particular range by stepping through the available frequency ranges and noting the animal's response to ultrasonic bursts at each frequency range. Once the frequency range most disturbing to the animal has been identified, the user can set the device to operate in that range. In response to bark detection in an automatic mode or to a manual trigger in either an automatic or manual mode of operation, the device administers a short ultrasonic burst in the programmed frequency range for a fixed time duration. When triggered manually, the length of the burst is the same regardless of how long the manual trigger remains activated.

### BACKGROUND OF THE INVENTION

1. Field of the Invention

The present invention is related to the field of ultrasonic animal training devices and, more particularly, to a device for training a dog using a short burst of ultrasonic tone that sweeps across multiple frequencies in a user-selected range.

2. Description of the Related Art

Depending upon its frequency, the emission of sound can be used to either encourage or discourage an animal from performing a specific action, such as barking, as is known from U.S. Pat. No. 5,724,919 (“the '919 patent”). In addition, it has been determined that the sound emitted can be more effective if it is varied using an oscillator or other device to create a frequency sweep. In the '919 patent, this frequency sweep is centered around about 26 KHz so that oscillation occurs at about 25-27 KHz. This frequency range may have varying effectiveness with different breeds of dogs or even individual dogs within a breed, with some being very responsive while others might react more strongly to a frequency range different from that offered by the unit.

Apart from the frequency applied, the duration of the emitted sound is also a factor in training effectiveness and is typically determined by the user during manual forms of operation. For example, training devices such as that embodied by the Ultrasonic Trainer Model 5150, marketed by Woodstream Corporation, the assignee of the present application, may be triggered automatically in response to detection of the target behavior, such as barking, or may be triggered by manual activation of a button or switch. During manual triggering, the duration of the emitted sound is dependent upon the length of time that the user keeps the button or switch in the activated position. This manual activation can reduce the effectiveness of the training device as the user, wanting to effect a stronger reaction in the dog, maintains activation of the tone for too long. Rather than producing a stronger reaction, however, the actual result is a weakened reaction for at least three reasons.

First, the dog finds it easier to habituate to, and ultimately ignore, a longer tone than a shorter burst. Second, shorter bursts provide a stronger startle reaction than do long tones, as when one hears a crack of thunder as compared to a train whistle. This stronger startle reaction increases the likelihood that the dog will be sufficiently distracted so as not to re-engage in the previous undesired behavior. Finally, a shorter burst makes it easier for the dog to accurately correlate the undesired behavior with the tone; a longer sound will encompass sequential behaviors occurring after the undesired behavior, making it harder for the dog to distinguish which behavior is the undesired behavior.

### SUMMARY OF THE INVENTION

In view of the foregoing, one object of the present invention is to overcome the difficulties of effectively distracting and training a dog or other animal to stop certain behaviors by using a device that delivers an ultrasonic stimulus emitted in short bursts of set duration.

Another object of the present invention is to provide an ultrasonic training device having adjustable output frequency ranges that enable the user to tune the device to a particular frequency range that produces maximum response from the animal.

A further object of the present invention is to provide an ultrasonic training device that can be operated in both manual and automatic modes in which triggering of the device produces a short ultrasonic burst having a set length regardless of mode.

Yet another object of the present invention is to provide an ultrasonic training device in which the output is a short ultrasonic burst in the form of a frequency sweep across a user-selected frequency range.

A still further object of the present invention is to provide an ultrasonic training device that can be repeatedly programmed and reprogrammed to different frequency ranges easily and quickly by the user of the device.

Yet a further object of the present invention is to provide an ultrasonic training device that is both humane and highly effective with virtually all breeds of dogs.

Still another object of the present invention is to provide an ultrasonic animal training device that is not complex or cumbersome in structure and which can be manufactured at low cost but yet effectively produces a range of ultrasonic output frequencies that can be adapted to suit different dogs and user requirements.

In accordance with these and other objects, the present invention is directed to an ultrasonic device for training a dog to cease from certain undesirable behaviors, such as barking, using a short ultrasonic burst that sweeps across multiple frequencies in a user-selected range. The device operates in both automatic and manual modes.

Prior to use, the user can program the device by stepping through a plurality of available frequency ranges and noting the animal's response to each frequency range. Once the frequency range most disturbing to the animal has been identified, the user can set the device to operate in that range. Alternately, a default frequency range can be used.

In automatic mode, the device is responsive to audible signals which enable the device to detect when an undesired behavior is occurring, e.g., the dog is barking. In response to bark detection, the device administers a short ultrasonic burst in the frequency range set during initial programming and for a pre-set duration. This burst duration is preferably approximately one second.

In manual mode, the user triggers the device to output an ultrasonic burst by activating a switch, button or other activation element on the device. When activated manually, the device emits the same short burst having the same duration as in automatic mode, i.e., the tone emitted has a set length regardless of whether the user releases or continues to hold the activation mechanism in the activated position. This ensures that the animal can accurately mark the undesired behavior, making the device more effective at extinguishing such behavior. Manual mode can be activated in response to a range of behaviors in addition to barking, such as urinating at an inappropriate location, digging, etc.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block diagram of the components of a programmable ultrasonic training device in accordance with the present invention.

FIG. 2 is an illustration of a hand-held unit embodying the programmable ultrasonic training device of FIG. 1.

FIG. 3 is a flowchart of the basic operation of the ultrasonic training device of FIG. 1.

FIG. 4 is a flowchart of the steps taken to program the frequency range output of the ultrasonic training device of FIG. 1.

### DETAILED DESCRIPTION OF THE PREFERRED EMBODIMENTS

Although only one preferred embodiment of the invention is explained in detail, it is to be understood that the embodiment is given by way of illustration only. It is not intended that the invention be limited in its scope to the details of construction and arrangement of components set forth in the following description or illustrated in the drawings. Also, in describing the preferred embodiments, specific terminology will be resorted to for the sake of clarity. It is to be understood that each specific term includes all technical equivalents which operate in a similar manner to accomplish a similar purpose.

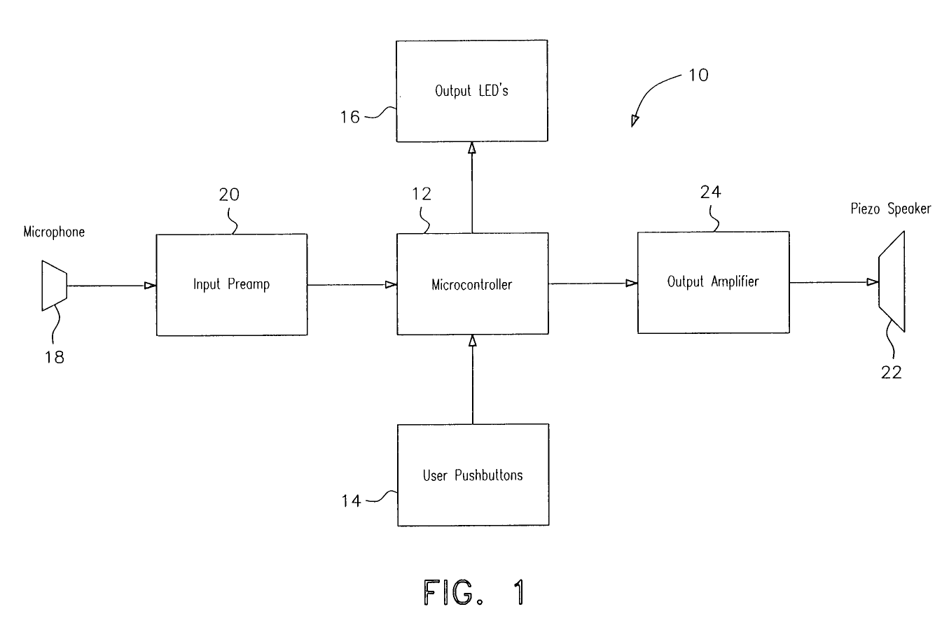

As set forth in FIG. 1, the present invention is directed to an ultrasonic training device generally designated by the reference numeral 10. The training device includes a microcontroller 12, at least one user input component 14, and at least one indicator component 16. In addition, the microcontroller 12 receives signal input from a microphone 18 that passes through an input preamplifier 20, and provides output to a speaker 22 through an output amplifier 24.

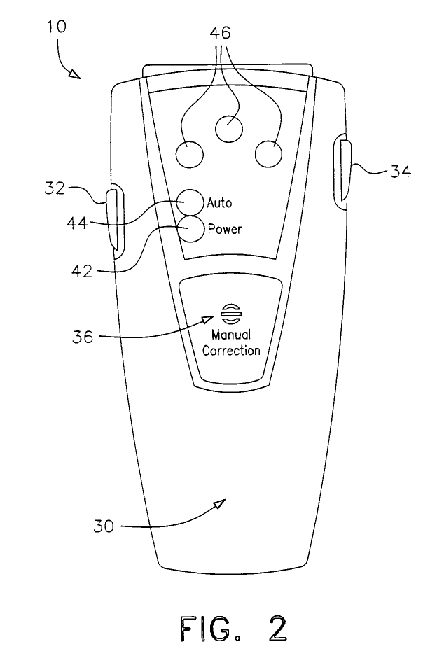

A representative hand-held unit 30 embodying the ultrasonic training device 10 is shown in FIG. 2. In this hand-held unit 30, the user input component 14 is embodied as a plurality of user input elements in the form of push buttons 32, 34, 36. Other input elements could also be used such as a touchscreen, switches, an adjustable rheostat, etc., as would be known by persons of ordinary skill in the art. The hand-held unit 30 can also be placed on a table or other support surface when direct manual activation is not needed.

A first push button, the power-on/mode button 32, is used to power up the unit and to select the mode of operation. According to a preferred embodiment, modes of operation include an automatic mode and a manual mode as will be discussed more fully hereinafter.

A second push button, the frequency selection button 34, allows the user to select the frequency range through which the unit will sweep when triggered to emit an ultrasonic burst. In the preferred embodiment discussed herein, there are five available frequency ranges covering sweeps of +/−750 Hz from 22 KHz to 30 KHz.

A third push button, the manual correction button 36, is provided to enable the user to manually trigger the emission of a sound output in the form of a frequency sweep in the selected range. The manual correction button 36 can be used to initiate sound output whether the unit is set to operate in either of the automatic or the manual modes.

Activation status of the device is shown by the indicator component 16 which, as shown in FIG. 2, may be embodied as a plurality of light emitting diodes (LEDs) 42, 44, 46. According to a preferred embodiment, these LEDs include a power LED 42 that indicates when the unit has been powered up, an automode LED 44 that indicates when the unit has been placed in the automatic mode, and three activation LEDs 46 that illuminate sequentially when the unit is emitting an ultrasonic output.

When the unit 10 has been triggered to emit an ultrasonic burst, whether through inputs to the microphone or by depression of the manual correction button 36, the ultrasonic response is a square wave output from the microcontroller 12 which is connected to a driver transistor that drives a piezo transducer in the speaker 22. The sound output has a set duration and is embodied as a frequency sweep in the frequency range previously selected by the user. The speaker 22 can be embodied using a piezoelectric element or any other suitable technology as would be known by persons of skill in the art.

In the manual mode of operation, the user triggers an ultrasonic burst by pressing down on the manual correction button 36. In the absence of user activation, the unit 10 will not initiate sound generation.

In the automatic mode of operation, the microcontroller 12 is responsive to inputs received from the microphone 18 that indicate barking. The bark signal from the microphone is amplified by input preamplifier 20 and run through a bandpass filter (not shown) having a center frequency of 400 Hz to reduce false triggering from non-bark noise. According to a preferred embodiment, the microphone 18 reacts to a threshold level of 85 dB as measured at the microphone.

When detecting whether the threshold level has been reached, the output of the preamplifier/filter is connected to an analog-to-digital converter in the microcontroller 12 which is used in comparator mode. The microcontroller initiates generation of a sound output when the microphone has detected a predetermined number of sounds at or above the threshold level within a specified time period such as, for example, two sounds of at least 85 dB each within one minute. The threshold level is preferably programmed into the microcontroller.

Once triggered, a high magnitude sonic ultrasound wave is emitted by the unit 10 for the set duration and in the user-selected frequency range. In a preferred embodiment, the set duration is about one second. Other durations of, for example, 0.25 seconds, 0.50 seconds, 0.75 seconds, etc. could, of course, be used. However, it has been determined that one second is long enough to reliably get the dog's attention without being so long that the benefits of a short burst, as discussed at the outset of this application, are lost.

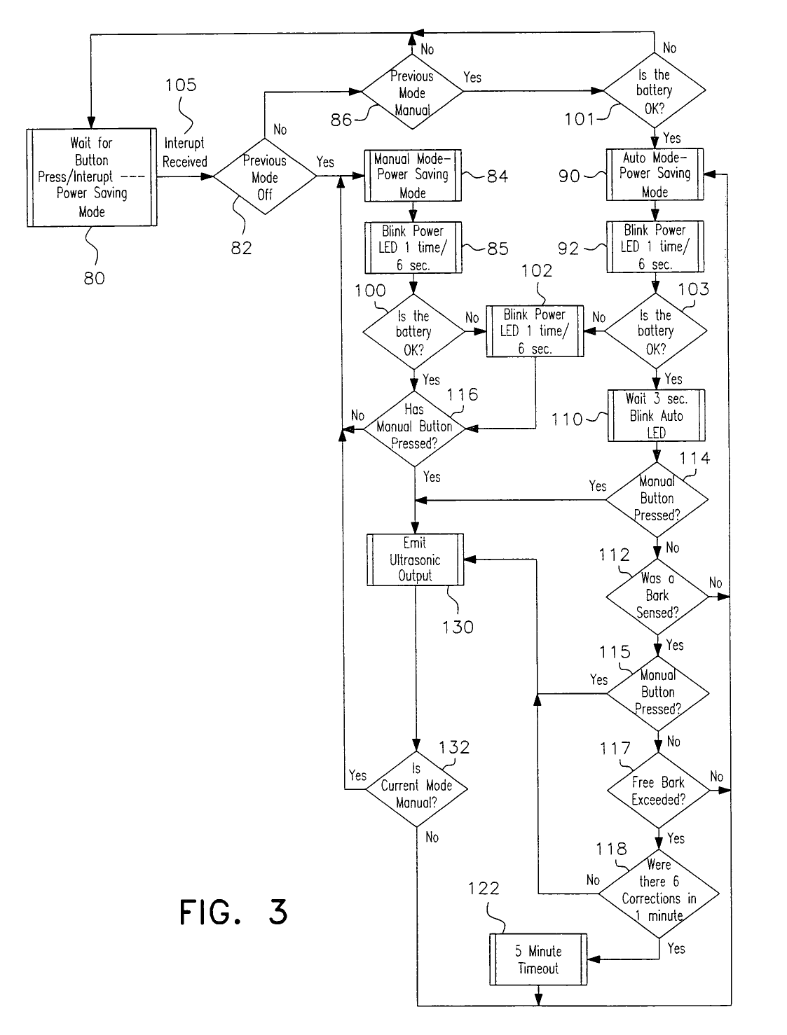

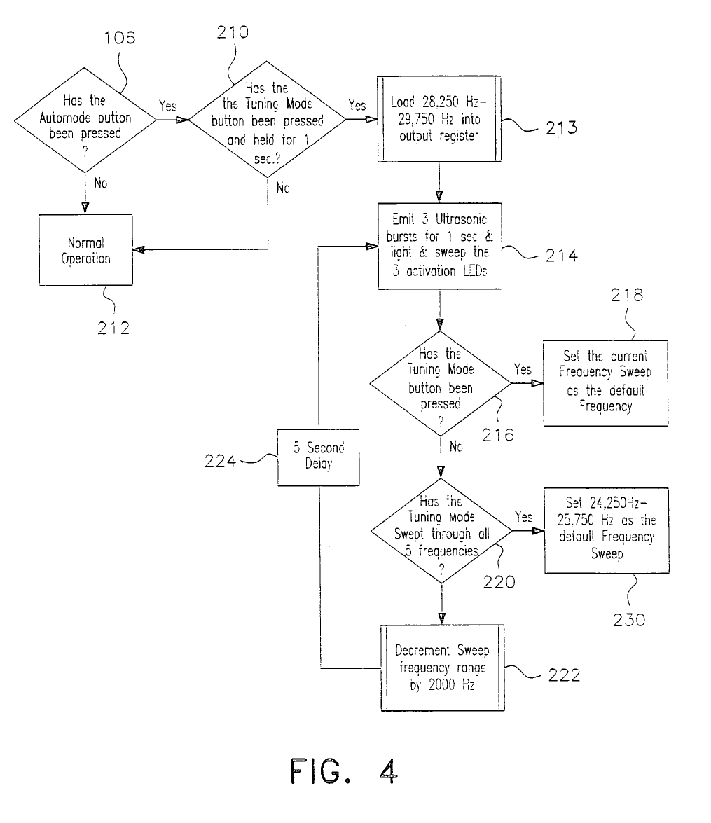

FIGS. 3 and 4 set forth the steps taken during normal operation of the device including the process of tuning the unit 10 to the frequency range desired by the user.

Starting with FIG. 3, when the unit 10 is off, it is in a state in which it is waiting for an interrupt by the user through the pressing of the power-on/mode button 32. Upon receiving the button press interrupt when the unit is off, the unit turns on. In addition, after the unit has been turned on, and in the absence of further immediate button press interrupts, the unit enters a related waiting state during which the unit waits for a further button press interrupt. The waiting state when the unit is “on” is referred to as the “power saving mode”. Both of these waiting states, namely when the unit is “off” and when the unit is in the “power saving mode”, are represented by block 80 in FIG. 3.

When an interrupt by the user through the pressing of the power-on/mode button 32 is received, step 105, the microcontroller 12 checks to see whether the unit's previous mode was “off”, step 82. If the previous mode was “off”, the unit enters the manual mode, step 84.

Upon entry to manual mode, step 84, the unit at the same time enters the “power saving mode”, step 80, in which the unit waits for a further button press interrupt. If an interrupt is received, step 105, the microcontroller 12 checks to see whether the unit's previous mode was “off”, step 82. Since in this circumstance the previous mode was not “off”, the microcontroller 12 checks to see whether the unit's previous mode was the manual mode, step 86. Since in this circumstance the previous mode was the manual mode, the microcontroller 12 checks the battery, step 101. If the battery power is low, the unit turns off, step 80. If the battery power is not low, step 101, the unit enters the automatic mode, step 90.

As when entering the manual mode, step 84, upon entry into the automatic mode, step 90, the unit at the same time enters the “power saving mode”, step 80, in which the unit waits for a further button press interrupt. If an interrupt is received, step 105, the microcontroller 12 checks to see whether the unit's previous mode was “off”, step 82. Since in this circumstance the previous mode was not “off”, the microcontroller 12 checks to see whether the unit's previous mode was the manual mode, step 86. Since in this circumstance the previous mode was not the manual mode, the unit turns off and awaits a further button press interrupt, step 80.

As just explained, the unit can be turned on by pressing the power-on/mode button once, step 105, from a state in which the unit is “off”, step 82. The unit initially enters the manual mode, step 84, but, in response to the user immediately pressing the power-on/mode button again, step 105, the microcontroller 12 determines that the previous mode was manual and the unit enters the automatic mode, step 90. In response to the user immediately pressing the power-on/mode button a third time, step 105, the microcontroller determines that the previous mode was automatic mode and the unit turns off to await a further button press interrupt, step 80, which will restart the cycle.

When a button press interrupt is received, step 105, the unit 10 checks to see if the power-on/mode button 32 has been pressed twice, indicating that automatic mode is desired, step 106. If so, the unit 10 checks to see if the frequency selection button 34 has been pressed and held for a predetermined period, such as one second, step 210 (see FIG. 4). If not, the unit 10 proceeds with normal operation, step 212, which continues as set forth in FIG. 3 at step 84.

Returning to step 84, upon entering the manual/power saving mode, the power LED 42 initiates blinking at a first repetition rate, step 85. The first repetition rate is preferably on the order of about one blink every six seconds. The unit then checks to see whether the battery level is sufficient, step 100. If the battery level is low, the power LED 42 initiates blinking at a second repetition rate that is visibly different from the first repetition rate, step 102. According to a preferred embodiment, the second repetition rate is about one blink of the power LED every second. Other repetition rates could also be used, including those in which the second repetition rate, indicating that the battery is low, is slower than the first repetition rate. What is desired is to have a visible difference in the blinking rates so the user is aware that the battery power is low.

After determining the status of the battery power, step 100, the unit waits for a further button press interrupt in the power saving mode. The further button press interrupt can be received from the power-on/mode button 32 or the manual activation button 36. As already described, a button press interrupt from the power-on/mode button 32, step 105, cycles the unit to the automatic mode, then to “off”, then to the manual mode, as has already been described. In the absence of a button press interrupt from either the power-on/mode button 32 or from the manual activation button, step 116, the unit remains in the manual power saving mode, step 84.

If a button press interrupt is received from the manual activation button 36, step 116, the unit emits an ultrasonic correction burst of the predetermined duration, e.g., one second, step 130. Concurrently with the sound burst, the unit sequentially lights the three activation LEDs 46 to indicate that a frequency sweep is being transmitted from the speaker 22. Upon completion of the frequency sweep and while in the manual mode, step 132, the unit returns to the manual power saving mode, step 84, with appropriate battery check, step 100.

If while operating in the manual mode, a button press interrupt is received from the power-on/mode button 32, step 105, the unit determines that the previous mode was not off, step 82, but was manual mode, step 86. As noted above, the microcontroller 12 then checks the battery, step 101. If the battery power is low, the unit turns off, step 80. If the battery power is not low, step 101, the unit enters the automatic mode, step 90.

Upon entering the automatic/power saving mode, the power LED 42 initiates blinking at a first repetition rate, step 92. The first repetition rate is preferably on the order of about one blink every six seconds. The unit then checks to see whether the battery level is sufficient, step 103. If the battery level is low, step 103, the power LED 42 initiates blinking at a second repetition rate that is visibly different from the first repetition rate, step 102. According to a preferred embodiment, the second repetition rate is about one blink of the power LED every second. Other repetition rates could also be used, including those in which the second repetition rate, indicating that the battery is low, is slower than the first repetition rate. What is desired is to have a visible difference in the blinking rates so the user is aware that the battery power is low.

After determining the status of the battery power, step 103, the automode LED 44 initiates blinking at a third repetition rate, step 110, which can be different from or the same as the first repetition rate. The unit then awaits detection of a bark and/or a further button press interrupt. If a bark is not detected, step 112, and if the manual activation button has not been pressed, step 114, the unit remains in the power saving mode, step 90, in which the automode LED 44 continues to blink at the set rate indicating the unit is in automatic mode. At this time, the unit is also in a waiting state with respect to a further button press interrupt from the power-on/mode button 32. As in the manual mode, a button press interrupt from the power-on/mode button 32, step 105, cycles the unit to “off”, then to the manual mode, and then to the automatic mode.

When a bark is detected, step 112, the unit checks to see if the manual activation button 36 has been pressed, step 115. If the manual activation button 36 has been pressed, step 115, the unit emits an ultrasonic correction burst of the predetermined duration, e.g., one second, step 130. Concurrently with the sound burst, the unit sequentially lights the three activation LEDs 46 to indicate that a frequency sweep is being transmitted from the speaker 22. Upon completion of the frequency sweep, the unit verifies the current mode, step 132, and returns to step 90.

When a bark has been detected, step 112, and the manual activation button 36 has not been pressed, step 115, the unit checks to determine whether a “free bark” threshold level has been exceeded, step 117. This free bark threshold level is preset in the unit and allows the dog to engage in some barking, short of excessive or nuisance barking. As examples, nuisance barking may be defined as more than one bark in one minute, more than five barks in one minute, etc., with the free bark threshold level being set in software accordingly. If the free bark threshold has not been exceeded, step 117, the unit returns to step 90 to await another bark or button press interrupt.

If the free bark threshold has been exceeded, step 117, the unit checks whether a threshold number of correction bursts, for example six, have been emitted in the previous minute, step 118. If not, the unit proceeds with emission of an ultrasonic correction burst accompanied by sequential lighting of the activation LEDs, step 130. Upon completion of the frequency sweep, the unit verifies the current mode, step 132, and returns to step 90.

If the unit has been activated at least six times in the previous minute as in step 118, however, the unit enters a time-out period of a predetermined duration such as, for example, five minutes, step 122. This time-out period helps to prevent the dog from becoming habituated to the sound bursts as might otherwise occur if the unit continued to generate repeated sound bursts within a very limited time period. During this time-out period, the stimulus causing the dog to bark may cease, allowing the dog to calm down and once again become receptive to subsequent ultrasonic burst emissions. Once the time-out period is over, the unit returns to step 90.

In the event that the unit has entered the time-out period, step 122, indicating that several frequently administered sound bursts have not been successful in distracting the dog from barking, the user may elect to reprogram or “tune” the unit to a different frequency range for the correction bursts. To initiate reprogramming, or for initial programming/tuning following unit power-up, the user follows the steps set forth in FIG. 4.

Particularly, to program or tune the unit to a particular frequency range from among the multiple ranges that are available, the user enters the tuning mode by pressing the power-on/mode button 32, step 106, an appropriate number of times to enter the automatic mode, followed by pressing and holding the frequency selection button 34 for one second, step 210. The unit responds by loading a first frequency range, for example, 28,250 Hz to 29,750 Hz, into an output register of the microcontroller, step 212. The unit then emits three ultrasonic sound bursts at the first frequency range and, at the same time, lights the three activation LEDs 46 sequentially to indicate that a frequency sweep is being emitted, step 214. If the first frequency range appears to be effective or is otherwise desired, the user can exit the tuning mode by pressing the frequency select button 34 again, step 216. This sets the first frequency range as the default range, step 218, after which the unit returns to normal operation in the automatic mode, step 90. Ultrasonic correction bursts initiated thereafter will be generated in the first frequency range.

If the first frequency range is not desired, the unit detects that the frequency selection button 34 has not been pressed to exit tuning mode, step 216. The unit then determines whether all five frequency ranges have already been swept through in the tuning mode, step 220. If not, the unit changes the sweep frequency to a second frequency range, step 222. According to a preferred embodiment, this second frequency range is about 2000 Hz lower than the first frequency range. Therefore, if the first frequency range is set at 28,250 Hz to 29,750 Hz as identified above, the second frequency range is between about 26,250 Hz and 27,750 Hz. The unit waits for a delay period of, for example, five seconds, step 224, and then emits three ultrasonic sound bursts in a frequency sweep at the second frequency range with concurrent lighting of the activation LEDs in a sweeping manner, step 214. The steps identified as steps 216, 218, 220, 222 and 224 are then repeated until the unit has swept through all five frequency ranges, step 220, or until the frequency selection button 34 has been pressed to exit tuning mode and set the current frequency range as the default range, step 218, whichever occurs first. If the unit proceeds through all five frequency ranges without the user selecting one of the frequency ranges, the unit will set a range of 24,250 Hz to 25,750 Hz as the default frequency, step 230. The unit will then return to normal operation in the automatic mode, step 90.

Whether the unit sets the range at the default frequency, step 230, or the frequency range is user-selected by pressing the tuning mode button, step 216, the resulting frequency range will thereafter be retained as the active range even if the unit is turned off and then turned back on to operate in the manual mode. Thus, while the original default frequency is initially set in software at 24,250-25,750 Hz, when the user tunes the frequency as summarized in FIG. 4, the frequency range chosen becomes the new default frequency range. This chosen frequency range is preferably stored in memory, such as a flash memory, and will remain the new default frequency range until a new frequency range is set using the tuning mode.

According to the preferred embodiment described herein, the overall frequency range from which the user can select one of several bands is from about 22 KHz to about 30 KHz and is divided into five distinct frequency bands of +/−750 Hz within that overall range (28,250-29,750 Hz; 26,250-27,750 Hz; 24,250-25,750 Hz; 22,250-23,750 Hz; 20,250-21,750 Hz). During manufacture, the microcontroller may be initially programmed to different starting and ending points of the overall range, as well as to different specific bands within the overall range, as would be understood by persons of ordinary skill in the art. However, the overall range disclosed herein has been determined to be very effective for use in training many varieties of dogs by generating a short-term stimulus in the form of an ultrasonic tone which is aimed at reducing the occurrence of behaviors through distraction at the time the behaviors are occurring.

The functions described herein relating to frequency range selection and the set duration of the ultrasonic sound bursts are preferably embodied in software within the microcontroller. As would be known by persons in the art, however, these functions could be embodied in hardware without departing from the scope of the invention.

The foregoing descriptions and drawings should be considered as illustrative only of the principles of the invention.

The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. An ultrasonic training device comprising:
a microcontroller configured to receive user inputs and to generate ultrasonic bursts of a set duration in either a manual mode or an automatic mode;
a user input component for inputting said user inputs to said microcontroller, said user input component including a manual correction element for triggering said microcontroller to generate an ultrasonic burst in either said manual mode or said automatic mode, said ultrasonic burst as triggered by pressing of said manual correction element being of said set duration regardless of how long said element is activated;
an output device connected to said microcontroller for emitting said ultrasonic bursts; and
a microphone for providing detected sound input to said microcontroller to trigger emission of an ultrasonic burst of said set duration in said automatic mode.

2. The ultrasonic training device of claim 1, wherein said set duration of said ultrasonic bursts is about one second.

3. The ultrasonic training device of claim 1, wherein said ultrasonic bursts are emitted in a frequency range that is selectable by the user from among a plurality of available frequency ranges.

4. The ultrasonic training device of claim 3, wherein said plurality of frequency ranges cover a frequency band of from about 22 KHz to about 30 KHz.

5. The ultrasonic training device of claim 4, wherein said plurality of frequency ranges includes five frequency ranges each separated from the immediately adjacent range or ranges by about 2 KHz.

6. The ultrasonic training device of claim 1, wherein said manual correction element is a button.

7. An ultrasonic training device comprising:
a microcontroller configured to receive user inputs and to generate ultrasonic correction bursts to distract a dog from engaging in an undesired behavior, said microcontroller being programmable to generate said ultrasonic bursts in one of a plurality of available frequency ranges;
a user input component for inputting said user inputs to said microcontroller, said user input component including a frequency selection element for triggering said microcontroller to generate said ultrasonic bursts in the frequency range selected by the user; and
an output device connected to said microcontroller for emitting said ultrasonic bursts.

8. The ultrasonic training device of claim 7, wherein said ultrasonic bursts, once triggered, are emitted for a set duration.

9. The ultrasonic training device of claim 8, wherein said set duration is about one second.

10. The ultrasonic training device of claim 7, wherein said microcontroller is programmable to operate in either a manual mode or an automatic mode, programming of said microcontroller to operate in a selected frequency range being operable in either of said modes.

11. The ultrasonic training device of claim 10, wherein said device further includes a microphone for providing detected sound input to said microcontroller to trigger emission of an ultrasonic burst in said automatic mode, said ultrasonic bursts being of a set duration in said automatic mode.

12. The ultrasonic training device of claim 11, wherein said user input component further includes a manual correction element for triggering said microcontroller to generate said ultrasonic bursts as triggered by the user through pressing of said manual correction element, said ultrasonic bursts when triggered manually being of a same set duration regardless of how long said manual correction element is activated.

13. The ultrasonic training device of claim 12, wherein said manual correction element is operable for user initiation in either said manual or automatic modes.

14. The ultrasonic training device of claim 13, wherein said plurality of frequency ranges cover a frequency band of from about 22 KHz to about 30 KHz.

15. The ultrasonic training device of claim 14, wherein said plurality of frequency ranges includes five frequency ranges each separated from the immediately adjacent range or ranges by about 2 KHz.

16. A method of operation demonstrated by an ultrasonic training device when being programmed to operate at a selected frequency range, said device including a microcontroller configured to receive user inputs and to generate ultrasonic bursts of a set duration in either a manual mode or an automatic mode, user input components for inputting said user inputs to said microcontroller, said user input components including a power-on/mode element for activating and setting an operational mode of said device and a frequency selection element, and an output device for outputting said ultrasonic bursts, said method comprising the steps of:
detecting, by said device, an activation input of said power-on/mode element being activated once;
entering, by said device, the automatic mode in response to said power-on/mode element being activated a second time;
entering, by said device, a tuning mode in response to said frequency selection element being activated and held for a set duration;
loading a first frequency range into said microcontroller;
emitting a first sample ultrasonic burst at said first frequency range by said output device;
setting, by said device in response to detecting that said frequency selection element has been activated again, said first frequency range as the selected frequency range;
checking, by said device in response to said frequency selection element not being activated, whether all available frequency ranges have been sampled;
loading, by said device in response to determining that at least one frequency range has not been sampled, a next available frequency range into said microcontroller;
emitting a second sample ultrasonic burst at said next frequency range by said output device;
setting, by said device in response to detecting that said frequency selection element has been activated again, said next frequency range as the selected frequency range;
checking, by said device in response to said frequency selection element not being activated, whether all available frequency ranges have been sampled; and
setting, by said device in response to determining that all available frequency ranges have been sampled, a default frequency range as the selected frequency range.

17. The method as set forth in claim 16, wherein said steps of emitting include emitting each ultrasonic burst for a set time duration as established by said microcontroller.

18. The method as set forth in claim 17, wherein said set time duration is about one second.
